(19) United States
(12) Patent Application Publication
(10) Pub. No.: US 2013/0141562 A1
(43) Pub. Date: Jun. 6, 2013

(54) MICROSCOPE

(71) Applicants: Masashi Yano, Utsunomiya-shi (JP); Hirofumi Fujii, Toyono-gun (JP); Michio Yanagisawa, Utsunomiya-shi (JP); Yukio Tokuda, Kawasaki-shi (JP)

(72) Inventors: Masashi Yano, Utsunomiya-shi (JP); Hirofumi Fujii, Toyono-gun (JP); Michio Yanagisawa, Utsunomiya-shi (JP); Yukio Tokuda, Kawasaki-shi (JP)

(73) Assignee: CANON KABUSHIKI KAISHA, Tokyo (JP)

(21) Appl. No.: 13/817,121

(22) PCT Filed: Aug. 5, 2011
(86) PCT No.: PCT/JP2011/004450

§ 371 Date: Feb. 14, 2013

(30) Foreign Application Priority Data
Aug. 18, 2010 (JP) 2010-183047

(51) Int. Cl. H04N 7/18

(52) U.S. Cl. 348/79

(57) ABSTRACT

A microscope according to the present invention includes an imaging unit including a first illuminating unit, an imaging element, and a projection optical system, the first illuminating unit including a light source that illuminates a first object, the imaging element performing imaging of the first object, the projection optical system projecting an image of the first object onto the imaging element; a measuring unit configured to measure a second object for setting an imaging condition used when performing imaging of the second object at the imaging unit; and a controller configured to concurrently perform the imaging of the first object at the imaging unit and the measurement of the second object at the measuring unit.

### TECHNICAL FIELD

The present invention relates to a system configuration of a microscope.

### BACKGROUND ART

As related systems related to measuring devices including a microscope, those discussed in PTL 1 and PTL 2 are provided. In PTL 1, after performing macro-inspection for visually observing a wafer surface for scratches and stains, micro-inspection is performed for closely inspecting with a microscope a location where confirmation of a feature is made. In a structure for performing such inspections, a macro-inspecting unit that is capable of rotating/tilting a wafer is provided between a carrier and a micro-inspecting unit. Although a wafer is often inspected using separate devices, that is, a macro-inspecting device and a micro-inspecting device, such a structure for performing such inspections makes it possible to simplify an inspection process.

In PTL 2, a structure includes an objective lens and a focus setting objective lens with an object being interposed therebetween on a same optical axis. Here, after performing a preliminary measurement using the focus setting objective lens, an actual measurement is performed using the objective lens. Therefore, it is possible to set the focus of the objective lens with high precision even if the thickness of a glass layer of the object is changed.

Accordingly, in such measuring devices including a microscope, a system configuration in which an actual measurement is performed by determining observation conditions as a result of previously measuring various characteristics of an object is often used. This is because, when the observation conditions are previously determined from results of the preliminary measurement, it is possible to minimize operations other than the observations performed during the actual measurement.

However, in recent years, there has been a demand for a method that takes a shorter time than the method of successively performing the preliminary measurement and the actual measurement (imaging) of each object as in PTL 1 and PTL 2 when a large number of objects are to be measured using a microscope.

### CITATION LIST

### Patent Literature

PTL 1: Japanese Patent Registration No. 02915864
PTL 2: Japanese Patent Registration No. 03715013

Accordingly, the present invention provides a structure that is capable of increasing throughput of measurement of a microscope.

### SUMMARY OF INVENTION

A microscope includes an imaging unit including a first illuminating unit, an imaging element, and a projection optical system, the first illuminating unit including a light source that illuminates a first object, the imaging element performing imaging of the first object, the projection optical system projecting the first object onto the imaging element; a measuring unit configured to measure a second object for setting an imaging condition used when performing imaging of the second object at the imaging unit; and a controller configured to concurrently perform the imaging of the first object at the imaging unit and the measurement of the second object at the measuring unit.

### BRIEF DESCRIPTION OF DRAWINGS

FIG. 1 shows an exemplary system configuration of a microscope according to a first embodiment of the present invention.

FIG. 2A shows Step 1 in an exemplary measurement sequence of the microscope according to the first embodiment of the present invention.

FIG. 2B shows Step 2 in the exemplary measurement sequence of the microscope according to the first embodiment of the present invention.

FIG. 2C shows Step 3 in the exemplary measurement sequence of the microscope according to the first embodiment of the present invention.

FIG. 2D shows Step 4 in the exemplary measurement sequence of the microscope according to the first embodiment of the present invention.

FIG. 2E shows Step 5 in the exemplary measurement sequence of the microscope according to the first embodiment of the present invention.

FIG. 3 shows an exemplary a system configuration of a microscope according to a second embodiment of the present invention.

FIG. 4A shows Step 1 in an exemplary measurement sequence of the microscope according to the second embodiment of the present invention.

FIG. 4B shows Step 2 in the exemplary measurement sequence of the microscope according to the second embodiment of the present invention.

FIG. 4C shows Step 3 in the exemplary measurement sequence of the microscope according to the second embodiment of the present invention.

FIG. 4D shows Step 4 in the exemplary measurement sequence of the microscope according to the second embodiment of the present invention.

FIG. 4E shows Step 5 in the exemplary measurement sequence of the microscope according to the second embodiment of the present invention.

### DESCRIPTION OF EMBODIMENTS

### First Embodiment

An exemplary system configuration of a microscope according to a first embodiment of the present invention will hereunder be described with reference to the drawings.

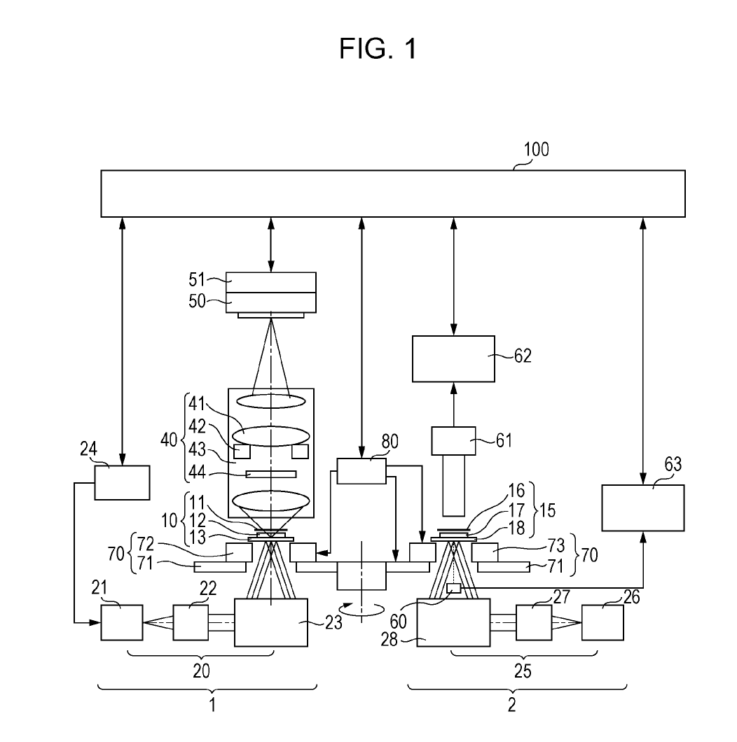

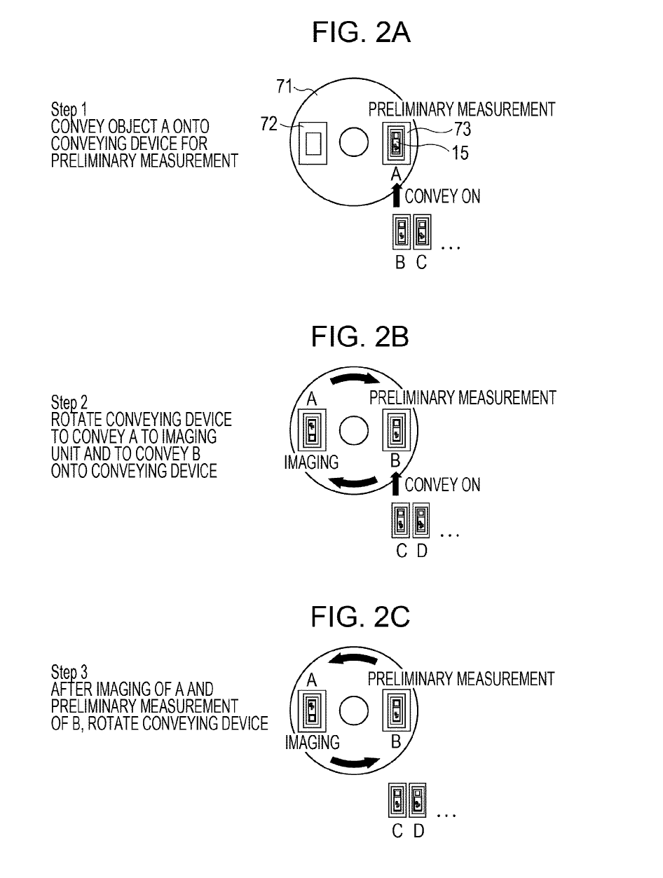

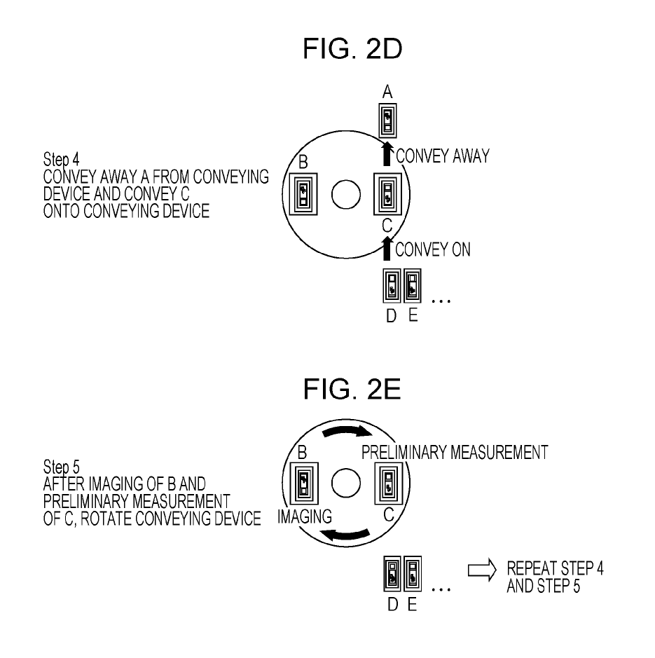

FIGS. 1 to 2E each show a system configuration for concurrently performing imaging of an object and performing a preliminary measurement of an object.

As shown from FIGS. 1 to 2E, an imaging unit 1 for performing imaging of an object includes a first illuminating unit 20 that illuminates a first object 10, a first imaging unit 50 that performs imaging of a projected image obtained through a projection unit 40, and a first image processing system 51 that processes an image obtained at the first imaging unit 50. Here, the first imaging unit 50 may be one in which a plurality of imaging elements (which are, for example, charge coupled device (CCD) sensors, complementary metal-oxide semiconductors (CMOS) sensors, or photoelectric tubes, and which are disposed, for example, linearly or in a matrix) are arranged side by side, or one including one imaging element.

The first object 10 includes a first cover glass 11, a first specimen 12, and a first slide glass 13. The first illuminating unit 20 includes, for example, a first light source 21, a first collimator 22 that shapes a light beam emitted from the first light source 21, and a first illumination optical system 23 including, for example, a lens and a mirror. For the first light source 21, for example, a mercury lamp or a light emitting diode (LED) is used. The projection unit 40 includes a projection optical system 41 and a lens barrel 43. The projection optical system 41 includes an optical system only including a lens or an optical system including a combination of a lens and a mirror. It is possible to use a drive adjusting mechanism 42 for optical elements for correcting, for example, aberrations of the optical system by adjusting the positions and orientations of, for example, the lens and the mirror. Further, it is possible to provide a mechanism that moves the optical elements, such as a parallel plate 44 for correcting an optical path length, into and out of, for example, the interior of the lens barrel 43, an optical path between the lens barrel 43 and the first imaging unit 50, and an optical path between the lens barrel 43 and the object 10. This makes it possible to correct optical path lengths when, for example, the thickness of the cover glass is changed. For example, a thick parallel plate is disposed when the cover glass is thin, whereas a thin parallel plate is disposed when the cover glass is thick.

A measuring unit 2 includes, for example, a displacement meter 60, a second illuminating unit 25, a second imaging unit 61, a second image processing system 62, and a displacement signal processing system 63. The measuring unit 2 performs measurement (preliminary measurement) for setting imaging conditions used when performing imaging of a second object 15 at the imaging section 1.

The second object 15 includes a second cover glass 16, a second specimen 17, and a second slide glass 18. The second illuminating unit 25 includes, for example, a second light source 26, a second collimator 27 that shapes a light beam emitted from the second light source 26, and a second illumination optical system 28 including, for example, a lens and a mirror. The image processing system 62 processes an image obtained at the second imaging unit 61. Here, the second imaging unit 61 may be one in which a plurality of imaging elements (which are, for example, CCD sensors, CMOS sensors, or photoelectric tubes, and which are disposed, for example, linearly or in a matrix) are arranged side by side, or one including one imaging element.

By such a device configuration, when the imaging at the imaging unit 1 and the preliminary measurement at the measuring unit 2 are concurrently performed, it is possible to increase measurement throughput when a plurality of objects are successively measured. Control for performing the concurrent operations is performed by a controller 100.

Conveyance of an object between a position where imaging is performed at the imaging unit 1 and a position where measurement is performed at the measuring unit 2 is performed by a conveying device 70 including a coarse rotation stage 71, a first fine motion stage 72, and a second fine motion stage 73. The first fine motion stage 72 and the second fine motion stage 73 hold the respective objects by vacuum attraction or a mechanical method. The first fine motion stage 72 and the second fine motion stage 73 are moved relative to the coarse rotation stage 71 in directions x, y, and z by, for example, a linear motor. For a driving source of the coarse rotation stage 71, for example, a linear motor, a USM, an AC motor, or a DC motor may be used. Here, although a conveying device including a coarse stage and fine motion stages is described, a structure not using fine motion stages may be used as long as positioning precision of the coarse rotation stage 71 is satisfactory. The coarse rotation stage 71, the first fine motion stage 72, and the second fine motion stage 73 are provided with openings so as to allow light from the illuminating units to illuminate the objects.

A sequence when performing successive operations on a plurality of objects is shown in FIGS. 2A to 2E.

In Step 1 (FIG. 2A), an object A is conveyed onto the first fine motion stage 72 to perform a preliminary measurement by the measuring unit 2. Here, if the object A is, for example, a prepared sample A for microscopic observation, its position, orientation, waviness, etc. are measured with the displacement meter 60. For the displacement meter 60, for example, a laser displacement meter, an ultrasonic displacement meter, or an optical displacement meter may be used. In the optical displacement meter, reflected light, obtained from light that is obliquely incident upon the prepared sample, is taken into a sensor. The second illuminating unit 25 and the second imaging unit 61 are used to measure the dimensions of the specimen included in the prepared sample, a quantity of transmitted light or a quantity of reflected light, and the thickness of the cover glass of the prepared sample.

In Step 2 (FIG. 2B), after conveying the prepared sample A to the imaging unit 1 by rotating the conveying device 70, a prepared sample B for microscopic observation is conveyed onto the second fine motion stage 73. Here, concurrently with these operations, the imaging conditions of the prepared sample A subjected to the preliminary measurement in Step 1 are set using the controller 100. Here, “setting the imaging conditions” means that, for example, on the basis of measurement results of waviness of the prepared sample A obtained by the displacement meter 60, the position and the orientation of the prepared sample are adjusted using the first fine motion stage 72 to adjust the prepared sample A to a focus position of the projection optical system. In addition, “setting the imaging conditions” includes a case in which, on the basis of the quantity of reflected light or the quantity of transmitted light obtained from the second illuminating unit 25 and the second imaging unit 61, a field-of-view blocking area, an imaging time, and the wavelength and a quantity of illumination light of the first illuminating unit 20 are adjusted. Further, “setting the imaging conditions” may include, for example, a case in which an area of existence of the specimen of the prepared sample is set to an imaging area where imaging is performed with the imaging element, or a case in which, for example, aberration is corrected using the drive adjusting mechanism 42 for adjusting the positions and orientations of, for example, the lens and the mirror. Here, if only the area of existence of the specimen of the prepared sample is processed as the imaging area, a required image processing operation of a required pixel only needs to be performed. Therefore, it is possible to further increase the measurement throughput. Consequently, for the first imaging unit 50, it is effective to use a CMOS sensor that is controlled by an address circuit allowing a partial read-out operation. The area of existence of the specimen can be identified from the quantity of transmitted light or the quantity of reflected light of the prepared sample. With the area of existence of the specimen being the imaging area, only a signal from a pixel situated at a position in accordance therewith is processed to obtain an image.

In the next Step 3 (FIG. 2C), concurrently with imaging of the prepared sample A, the prepared sample B is preliminarily measured. After the imaging of the prepared sample A and the preliminary measurement of the prepared sample B end, imaging conditions in the imaging unit 1 are set in accordance with the prepared sample B concurrently with the rotation of the conveying device 70. Here, when, for example, wires are provided in the conveying device 70, it is effective to use a slip ring or to reverse the direction of rotation to a direction opposite to that in Step 2 so that twisting of the wires does not occur.

Next, in Step 4 (FIG. 2D), the prepared sample A is conveyed away from the first fine motion stage 72, and a prepared sample C is conveyed onto the first fine motion stage 72.

In Step 5 (FIG. 2E), after concurrently performing imaging of the prepared sample B and preliminary measurement of the prepared sample C, imaging conditions in the imaging unit 1 are set in accordance with the prepared sample C concurrently with the rotation of the conveying device 70.

Thereafter, the operations of Steps 4 and 5 are repeated.

Accordingly, by concurrently performing the respective imagings and the respective preliminary measurements, it is possible to increase throughput.

### Second Embodiment

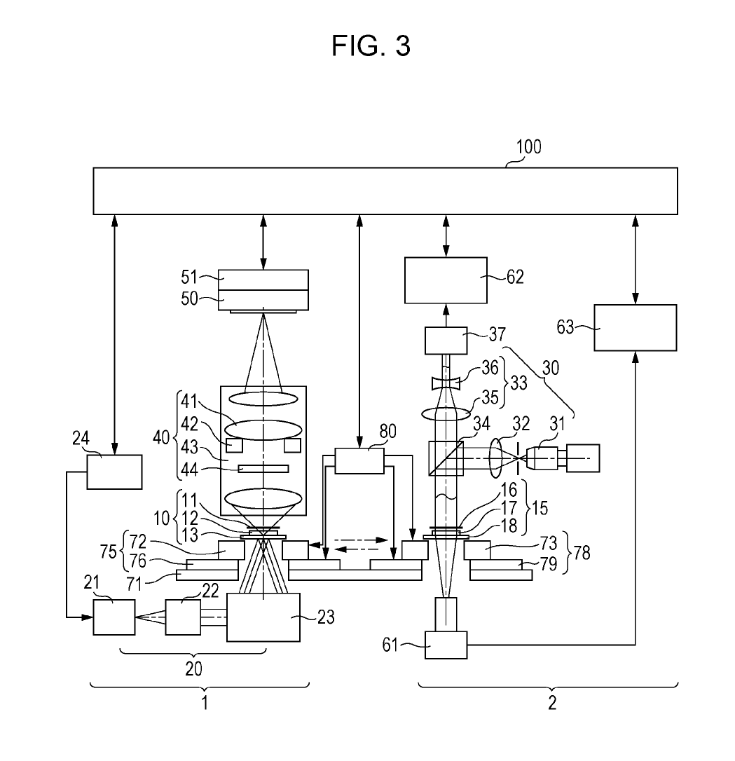

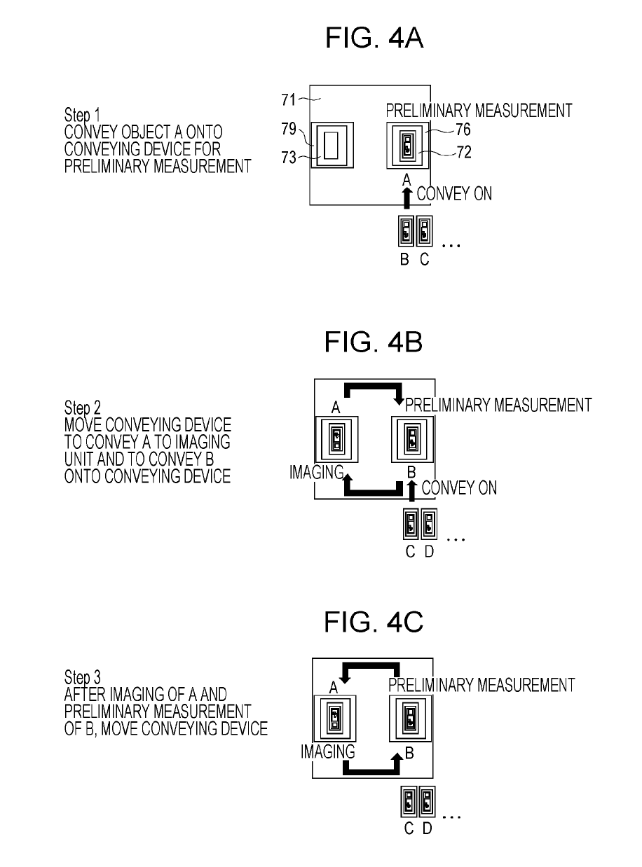

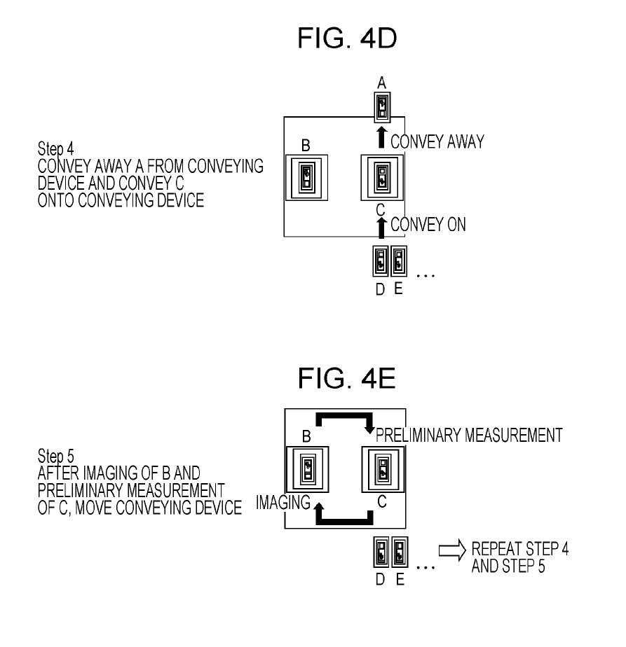

A second embodiment will be described with reference to FIGS. 3 to 4E. A system configuration shown here primarily differs from the system configuration according to the first embodiment in that the structures of a conveying device and a preliminary measuring unit for objects differ from those of the system configuration according to the first embodiment.

A measuring unit 2 includes, for example, a second illuminating unit 30, a ShackHartmann sensor 37, a second imaging unit 61, a second image processing system 62, and a displacement signal processing system 63. The measuring unit 2 performs measurement (preliminary measurement) for setting imaging conditions used when performing imaging of a second object 15 at an imaging unit 1.

The second object 15 includes of a second cover glass 16, a second specimen 17, and a slide glass 18. The second illuminating unit 30 includes, for example, a second light source 31, a second collimator 32 that shapes a light beam emitted from the second light source 31, a beam splitter 34, and a second illumination optical system 33 including, for example, a convex lens 35 and a concave lens 36. Here, the convex lens and the concave lens 36 are provided for correcting aberrations by enlarging and contracting illumination light. The number and structures of the convex and concave lenses are not limited to those shown. The second image processing system 62 processes an image obtained at the second imaging unit 61.

As shown in FIG. 3, a conveying device includes a first conveying device 75 and a second conveying device 78. The first conveying device 75 includes a first coarse motion stage 76 and a first fine motion stage 72. The second conveying device 78 includes a second coarse motion stage 79 and a second fine motion stage 73. The first coarse stage 76 and the second coarse motion stage 79 each include a magnet. The magnets and coils provided at stators 81 constitute Lorentz planar motors. The first fine motion stage 72 and the second fine motion stage 73 are moved relative to the first coarse motion stage 76 and the second coarse motion stage 79, respectively, in directions x, y, and z by, for example, linear motors. Here, although structures using coarse and fine motion stages are used, structures not using fine motion stages may be used by using stators provided with coils that are placed upon each other in a plurality of layers. Alternatively, a structure in which coils are used at the first coarse motion stage 76 and at the second coarse motion stage 79, and in which magnets are used at the stators 81 may also be used. Further, instead of the aforementioned Lorentz planar motors, planar pulse motors may also be used.

The stators 81, the first coarse motion stage 76, the second coarse motion stage 79, the first fine motion stage 72, and the second fine motion stage 73 are provided with openings so as to allow light from the illuminating units to illuminate the objects. The other points are the same as those of the first embodiment, so that they will not be described below.

A sequence when successively performing operations on a plurality of objects is shown from FIGS. 4A to 4E. In Step 1 (FIG. 4A), an object A is conveyed onto the conveying device to perform preliminary measurement. Here, if the object A is, for example, a prepared sample A for microscopic observation, its waviness, etc. are measured with the second illuminating unit 30, the Shack-Hartmann sensor 37, etc. The second illuminating unit 30, the second imaging unit 61, etc. are used to measure a quantity of transmitted light or a quantity of reflected light, and the thickness of the cover glass of the prepared sample. In Step 2 (FIG. 4B), the first conveying device 75 and the second conveying device 78 are moved horizontally and their positions are swapped, to convey the prepared sample A to the imaging unit 1. Then, a prepared sample B is conveyed to the measuring unit 2. Here, concurrently with these operations, imaging conditions of the prepared sample A subjected to the preliminary measurement in Step 1 are set using the controller 100.

In the next Step 3 (FIG. 4C), concurrently with imaging of the prepared sample A, the prepared sample B is preliminarily measured using the controller 100. After the imaging of the prepared sample A and the preliminary measurement of the prepared sample B end, imaging conditions in the imaging unit 1 are set in accordance with the prepared sample B concurrently with horizontal movement of the first conveying device 75 and the second conveying device 78 and swapping of their positions. Here, when, for example, wires are provided in the first conveying device 75 and the second conveying device 78, it is effective to reverse the direction of movement to a direction opposite to that in Step 2 so that twisting of the wires does not occur.

Next, in Step 4 (FIG. 4D), the prepared sample A is conveyed away from the conveying device, and a prepared sample C is conveyed onto the conveying device.

In Step 5 (FIG. 4E), after concurrently performing imaging of the prepared sample B and preliminary measurement of the prepared sample C, imaging conditions in the imaging unit 1 are set in accordance with the prepared sample C concurrently with horizontal movement of the first conveying device 75 and the second conveying device 78 and swapping of their positions.

Thereafter, the operations of Steps 4 and 5 are repeated.

Although, in the embodiment, stages are used as the conveying devices, the objects may be conveyed using, for example, a belt conveyor or a robot hand.

Accordingly, in the first embodiment, a structure using a rotation stage for moving prepared samples and using a displacement meter for preliminary measurement is described. In the second embodiment, a structure using planar motors for moving prepared samples and using a Shack-Hartmann sensor for preliminary measurement is described. However, it is possible to use a structure using a rotation stage for moving prepared samples and using a Shack-Hartmann sensor for preliminary measurement, or to use a structure using planar motors for moving prepared samples and using a displacement meter for preliminary measurement.

Considering the ideas of the present invention, the structure for moving prepared samples and performing preliminary measurements is not particularly limited as long as imaging of one of the objects and preliminary measurement of the other object can be concurrently performed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-183047, filed Aug. 18, 2010, which is hereby incorporated by reference herein in its entirety.

1. A microscope comprising:
an imaging unit a first object being projected by a projection optical system onto an imaging element;
a measuring unit configured to measure a second object for setting an imaging condition used when performing imaging of the second object at the imaging unit;
a conveying configured to convey the second object from a position where the measurement is performed by the measuring unit to a position where the imaging is performed by the imaging unit; and
a controller configured to concurrently perform the imaging of the first object at the imaging unit and the measurement of the second object at the measuring unit,
wherein the controller concurrently performs the conveyance of the second object by the conveying unit and the setting of the imaging condition used when performing the imaging of the second object at the imaging unit based on a measurement result of the second object at the measuring unit.

2. (canceled)

3. (canceled)

4. (canceled)

5. The microscope according to claim 1, wherein the imaging unit is a complementary metal-oxide semiconductor sensor being controlled by an address circuit allowing a partial read-out operation, and
wherein the imaging unit selects an address of a read-out pixel of the complementary metal-oxide semiconductor sensor in accordance with an imaging area of either the first or the second object.

6. The microscope according to claim 1, wherein the projection optical system includes a lens and a mirror,
further comprising an adjusting mechanism, the adjusting mechanism correcting aberrations of the optical system by adjusting at least positions or orientations of at least the lens or the mirror.

7. The microscope according to claim 1, wherein the conveying unit is a rotation stage.

8. The microscope according to claim 7, wherein the rotation stage includes a fine motion stage holding the second object, and
wherein the rotation stage and the fine motion stage are provided with openings so as to allow light from an illuminating unit to pass through.

9. The microscope according to claim 8, wherein the fine motion stage holds the second object by vacuum attraction or a mechanical method.

10. The microscope according to claim 1, wherein the conveying unit comprises a first conveying device including a first coarse stage and a first fine motion stage and holding the first object and a second conveying device including a second coarse stage and a second fine motion stage and holding the second object, and
wherein the controller performs conveyance of the first object by the first conveying unit from the imaging unit to a position where the first object is conveyed away concurrently with the conveyance of the second object from the position where the measurement is performed by the measuring unit to the position where the imaging is performed by the imaging unit.

11. A microscope comprising:
an imaging unit configured to perform imaging of a first object being projected by a projection optical system onto an imaging element;
a measuring unit configured to measure a second object for setting an imaging condition used when performing imaging of the second object by the imaging unit; and
a controller configured to concurrently perform the imaging of the first object by the imaging unit and the measurement of the second object by the measuring unit,
wherein the second object includes a specimen,
wherein the measuring unit performs one or more of a measurement of at least one of a position, an orientation, a thickness and a waviness of the second object, a measurement of a quantity of transmitted light or reflected light, and a measurement of a dimension of the specimen, and
wherein the controller sets the imaging condition based on a measurement result at the measuring unit.

12. The microscope according to claim 11, wherein the second object further includes a cover glass,
wherein the measuring unit performs one or more of a measurement of at least one of a position, an orientation, a thickness and a waviness of the second object, a measurement of a quantity of transmitted light or reflected light, a measurement of a dimension of the specimen and a measurement of a thickness of the cover glass, and
wherein the controller sets the imaging condition based on the measurement result at the measuring unit.

13. The microscope according to claim 12, further comprising:
a plurality of optical elements which can be put in an optical path of the imaging unit,
wherein an optical element to be put in the optical path is determined from among the plurality of optical elements in accordance with the thickness of the cover glass.

14. The microscope according to claim 11, wherein the measurement of the waviness is performed by using a laser displacement meter, an ultrasonic displacement meter or an optical displacement meter of an oblique incidence type.

15. The microscope according to claim 11, wherein the imaging element is a complementary metal-oxide semiconductor sensor being controlled by an address circuit allowing a partial read-out operation, and
wherein the imaging unit selects an address of a read-out pixel of the complementary metal-oxide semiconductor sensor in accordance with an imaging area of either the first or the second object.

16. The microscope according to claim 11, wherein the projection optical system includes a lens and a mirror,
further comprising an adjusting mechanism, the adjusting mechanism correcting aberrations of the optical system by adjusting at least positions or orientations of at least the lens or the mirror.

17. The microscope according to claim 11, further comprising a conveying unit configured to convey the second object from a position where the measurement is performed by the measuring unit to a position where the imaging is performed by the imaging unit.

18. The microscope according to claim 17, wherein the controller concurrently performs the conveyance of the second object by the conveying unit and the setting of the imaging condition used when performing the imaging of the second object at the imaging unit based on the measurement result of the second object at the measuring unit.

19. The microscope according to claim 17, wherein the conveying unit is a rotation stage.

20. The microscope according to claim 19, wherein the rotation stage includes a fine motion stage holding the second object, and
wherein the rotation stage and the fine motion stage are provided with openings so as to allow light from an illuminating unit to pass through.

21. The microscope according to claim 20, wherein the fine motion stage holds the first object and the second object by vacuum attraction or a mechanical method.

22. The microscope according to claim 17, wherein the conveying unit comprises a first conveying device including a first coarse stage and a first fine motion stage and holding the first object and a second conveying device including a second coarse stage and a second fine motion stage and holding the second object, and
wherein the controller performs conveyance of the first object by the first conveying unit from the imaging unit to a position where the first object is conveyed away concurrently with the conveyance of the second object from the position where the measurement is performed by the measuring unit to the position where the imaging is performed by the imaging unit.

23. A microscope comprising:
an imaging unit configured to perform imaging of a first objet being projected by a projection optical system onto an imaging element;
a measuring unit configured to measure the second object for setting an imaging condition used when performing imaging of the second object at the imaging unit; and
a controller configured to concurrently perform the imaging of the first object by the imaging unit and the measurement of the second object by the measuring unit,
wherein the imaging condition includes one or more of a position or an orientation of the second object when performing the imaging of the second object by the imaging unit, an quantity or a wavelength of a light illuminating the second object, and any of an imaging area, an imaging time, a field-of-view blocking area, and an optical path correction when performing the imaging of the second object.

24. The microscope according to claim 23, wherein the imaging element is a complementary metal-oxide semiconductor sensor being controlled by an address circuit allowing a partial read-out operation, and
wherein the imaging unit selects an address of a read-out pixel of the complementary metal-oxide semiconductor sensor in accordance with an imaging area of either the first or the second object.

25. The microscope according to claim 23, wherein the projection optical system includes a lens and a mirror, an adjusting mechanism, the adjusting mechanism correcting aberrations of the optical system by adjusting at least positions or orientations of at least the lens or the mirror.

26. The microscope according to claim 23, further comprising a conveying unit configured to convey the second object from a position where the measurement is performed by the measuring unit to a position where the imaging is performed by the imaging unit.

27. The microscope according to claim 26, wherein the controller concurrently performs the conveyance of the second object by the conveying unit and the setting of the imaging condition used when performing the imaging of the second object at the imaging unit based on the measurement result of the second object at the measuring unit.

28. The microscope according to claim 26, wherein the conveying unit is a rotation stage.

29. The microscope according to claim 28, wherein the rotation stage includes a fine motion stage holding the second object, and
wherein the rotation stage and the fine motion stage are provided with openings so as to allow light from an illuminating unit to pass through.

30. The microscope according to claim 29, wherein the fine motion stage holds the first object and the second object by vacuum attraction or a mechanical method.

31. The microscope according to claim 26, wherein the conveying unit comprises a first conveying device including a first coarse stage and a first fine motion stage and holding the first object and a second conveying device including a second coarse stage and a second fine motion stage and holding the second object, and
wherein the controller performs conveyance of the first object by the first conveying unit from the imaging unit to a position where the first object is conveyed away concurrently with the conveyance of the second object from the position where the measurement is performed by the measuring unit to the position where the imaging is performed by the imaging unit.
